(19) United States
(12) Patent Application Publication
(10) Pub. No.: US 2006/0286248 A1
(43) Pub. Date: Dec. 21, 2006

(54) Reduced-carbohydrate and nutritionally-enhanced frozen desserts and other food products

(76) Inventors: Jon R. Anfinsen, Alachua, FL (US); Bryan Craig Tungland, Becker, MN (US)

Correspondence Address: HASSE & NESBITT LLC, 8837 CHAPEL SQUARE DRIVE, SUITE C, CINCINNATI, OH, 45249, US

(21) Appl. No.: 10/958,095

(22) Filed: Oct. 4, 2004

Related U.S. Application Data
(60) Provisional application No. 60/481,461, filed on Oct. 2, 2003.

(51) Int. Cl. A23G 9/00

(52) U.S. Cl. 426/565

(57) ABSTRACT

A reduced carbohydrate ice cream or other frozen dessert product that contains a low-digestible sweetener system and a fermentable fiber material. The a low-digestible sweetener system consists of one or more low-digestible sweeteners having a molecular weight of from about 90 to about 190; and is typically a low molecular weight saccharide or a polyol. Typical low-digestible sweeteners include mannitol, maltitol, sorbitol, lactitol, erythritol, xylitol, isomalt, glycerin, talitol, mannose, tagatose, fructose, arabinose, fucose, lycose, ribose, sorbose, talose, and xylose, and mixtures thereof. The low-digestible sweetener replaces the digestible sugars to provide the appropriate freezing point depression of the product. The level of fermentable fiber is sufficient to mitigate a Taxation effect that can be caused by ingestion of the amount of the low-digestive sweetener. The fermentable fiber can be an inulin, a maltodextrin resistant to human digestion, an oligofructose, a fructooligosaccharide, a high water binding fermentable fiber, and a mixture thereof.

### BACKGROUND OF THE INVENTION

The present invention relates to a reduced-carbohydrate sweetener system, and to frozen desserts and other foods containing the reduced-carbohydrate sweetener system.

An estimated 63 percent of Americans are overweight or obese. These conditions substantially raise the risk of morbidity and mortality from hypertension, dyslipidemia, type 2 diabetes, coronary heart disease, stroke, gallbladder disease, osteoarthritis, sleep apnea, respiratory problems, and endometrial, breast, prostate, and colon cancers. The total annual cost attributable to obesity-related diseases is nearly $140 billion. Overweight and obesity pose a major public health challenge.

Diabetes is considered to be a cause of obesity while being obese and overweight often results in type II diabetes. The common factor is a malfunction in the metabolism of digestible carbohydrates. This malfunction increases blood glucose and insulin levels that result in the production and storage of fat. High levels of glucose in the blood stream bind to organ proteins (glycosylation) resulting in the deterioration of organ function.

It is evident that diabetics and those that are overweight and obese should usually avoid foods having a high blood glucose response, i.e. those that result in a relatively high level of blood glucose soon after digestion of a food or meal. Instead, diabetics and those controlling their weight require foods that induce a relatively low blood glucose response, which results in a slower rate of glucose release into the blood. Slowing the rate of release of glucose into the blood reduces the risk of both hyperglycemia and hypoglycemia and the related number of chronic, serious disease conditions.

During the process of digestion in the small intestine, digestible carbohydrates composed of polysaccharides, oligosaccharides and disaccharides are hydrolyzed to monosaccharides; glucose, fructose and galactose. The monosaccharides are absorbed into the blood stream and carried to the liver where fructose and galactose are converted to glucose. The result is an increase in blood glucose level, which occurs 30 to 45 minutes after ingestion of a food. This increase in blood glucose level is characterized as “blood glucose response”. Non-digestible carbohydrates such as polyols and dietary fibers bypass the small intestine and enter the colon. Dietary fibers are fermented or if resistant to fermentation are excreted. Polyols are primarily fermented in the colon versus being digested and absorbed in the small intestine.

Polyols and certain other low molecular weight monosaccharides (MW of about 90 to 190) are small molecules that as a result of their colligative effects can create adverse levels of osmotic pressure in the colon causing laxation effects that can include diarrhea and gastrointestinal discomfort. The laxation threshold of low molecular weight sweeteners varies. Mannitol and sorbitol have low thresholds of tolerance while erythritol and glycerin have high thresholds. Children have lower levels of tolerance than adults. The enhanced intolerance of children is due to their short colons and low colon mass. Adults have longer colons and higher colon mass and can better tolerate these low molecular weight sugar alcohols and saccharides.

Frozen desserts are typically high in digestible carbohydrates. Common sweeteners used in frozen desserts include, sugar, corn syrup, high fructose corn syrup, fructose, glucose, lactose, honey, molasses, maltose, and sugar alcohols (maltitol, maltitol syrups, sorbitol, isomalt, lactitol, erythritol, and xylitol), also referred to as “polyols”. With the exception of polyols and fructose, commonly used frozen dessert sweeteners generally have moderate to high glycemic indices in the range of 50 to 110. Predominately used frozen dessert sweeteners high in digestible carbohydrates include sucrose, corn syrup and high fructose corn syrup. Molecular weights for these sweeteners range from about 180 to above 4,000 and more. Since frozen desserts are highly consumed, they represent a significant source of digestible carbohydrates in the diet.

The reduction of digestible carbohydrate levels in highly-consumed foods, such as confections, nutritional bars, baked goods, and frozen desserts, can offer important benefits: 1) the promotion of weight loss and weight control, 2) reduction of the incidence of Type II diabetes, 3) lowering of the morbidity and mortality resulting from diabetes and conditions of obesity, and 4) the reduction of related healthcare costs.

Standards for frozen desserts are published in the United States by states and the United States Federal Government. Federal regulations for frozen desserts are published in Title 21 CFR (Code of Federal Regulations), Part 135. These regulations provide definitions and requirements for specific standardized frozen desserts. Title 7 of the Pennsylvania Code, Chapter 39 (No. 262 Sep. 96) also provides detailed standards for frozen desserts

### SUMMARY OF THE INVENTION

The present invention relates to a frozen dessert product comprising: a) a low-digestible sweetener system comprising: (1) at least one low-digestible sweetener having a molecular weight of from about 90 to about 190; and (2) an optional non-nutritive sweetener; and b) a fermentable fiber material.

The present invention relates also to a frozen dessert product comprising: a) a freezing point depression system consisting essentially of at least one Freezing Point Depression Sweetener having a molecular weight of from about 90 to about 190; b) an optional non-nutritive sweetener; and c) a fermentable fiber material.

The present invention further relates to an ice cream comprising: a) at least 10% milkfat, b) a low-digestible sweetener system comprising: (1) at least one low-digestible sweetener having a molecular weight of from about 90 to about 190; and (2) at least one non-nutritive sweetener; and (3) a fermentable fiber material.

The present invention can also relate to an ice cream comprising: a) at least 10% milkfat; b) a freezing point depression system consisting essentially of at least one Freezing Point Depression Sweetener having a molecular weight of from about 90 to about 190; c) at least one non-nutritive sweetener; and d) a fermentable fiber material.

The present invention also relates to a low-digestible sweetener system for use in foods and beverages, the sweetener system comprising: a) an amount of at least one low-digestive sweetener having a molecular weight of from about 90 to about 190, and having a Taxation threshold less than about 150 g; b) an optional non-nutritive sweetener; and c) an amount of a fermentable fiber material, wherein the amount of fermentable fiber used is sufficient to mitigate a laxation effect that can be caused by ingestion of the amount of the low-digestive sweetener.

The present invention relates further to a low-digestible sweetener system for use in a frozen dessert, the sweetener system comprising: a) at least one Freezing Point Depression Sweetener having a molecular weight of from about 90 to about 190, and b) a fermentable fiber material.

The present invention also relates to a low-digestible sweetener system for use in foods, that contributes 5 grams and less of digestible carbohydrate per standardized serving of the food, and that displays the organoleptic and physical properties of a conventional food product containing a standard level of conventional digestible carbohydrate, wherein the low-digestible sweetener system comprises: a) at least one low-digestible sweetener having a molecular weight of from about 90 to about 190, and b) a fermentable fiber material.

The present invention also relates to a low-digestible sweetener system for use in frozen desserts that provides a freezing point depression to the frozen dessert, that contributes 5 grams and less of digestible carbohydrate per standardized serving of frozen dessert, and that displays the organoleptic and physical properties of a conventional frozen dessert product containing a standard level of conventional digestible carbohydrate, wherein the low-digestible sweetener system comprises: a) at least one Freezing Point Depression Sweetener having a molecular weight of from about 90 to about 190, and b) a fermentable fiber material.

The present invention relates also to a frozen dessert product comprising a fermentable fiber material selected from the group consisting of inulin, a maltodextrin resistant to human digestion, an oligofructose, a non-digestible soluble fiber, and a mixture thereof.

The present invention can also relate to a use of a fermentable fiber in a frozen dessert containing at least one low-digestible sweetener having a molecular weight of from about 90 to about 190, to mitigate the laxation effect that can be caused by ingestion of such amount of the low-digestible sweetener.

The present invention further relates to a use of a low-digestible sweetener system in a frozen dessert to provide freezing point depression, where the low-digestible sweetener system comprises at least one low-digestible sweetener having a molecular weight of from about 90 to about 190, and wherein the freezing point depression provides a draw temperature of about 19 to 20° F. (about −7° C.).

The present invention also relates to frozen dessert that comprises at least one low-digestible sweetener having a molecular weight of from about 90 to about 190; an optional non-nutritive sweetener; a fermentable fiber material, and a probiotic material.

### BRIEF DESCRIPTION OF THE FIGURE

FIG. 1 shows an image of an ice cream of the present invention having physical properties that simulate those of a conventional ice cream.

FIG. 2 shows an image of a conventional ice cream.

### DETAILED DESCRIPTION OF THE INVENTION

### Definitions

As used herein, the term “frozen dessert” means any frozen or partially frozen product, and includes any frozen dessert product designed by the product definitions and specific product requirements provided by Title 21 CFR (Code of Federal Regulations), Part 135 and/or Title 7 of the Pennsylvania Code, Chapter 39 (No. 262 Sep. 96), and can include, but is not limited to: ice cream, frozen custard, French ice cream, French custard ice cream, frozen dietary dairy dessert, frozen yogurt, dietary frozen dessert, or low-fat frozen dairy dessert, ice milk, freezer made milk shakes, fruit sherbet, water ices, quiescently frozen confection, quiescently frozen dairy confection, whipped cream confections, bisque tortoni, mellorine frozen desserts, and goat's milk ice cream, as well as a product that is similar in appearance, odor, or taste to such products, or that is prepared or frozen as a frozen dessert is customarily prepared or frozen, whether made with dairy products or non dairy products.

As used herein, “low-digestible”, in the context of a food product containing a sweetener system of the present invention, means a food product having a reduced level of digestible carbohydrates as compared with a counterpart product made with a conventional sweetener system; more particularly, “low-digestible” typically means having at least about a 20% reduction in digestible carbohydrates per standardized serving. In the context of a sweetener system, “low-digestible” means a sweetener system that contains a reduced level of digestible carbohydrates as compared with conventional sweetener systems used in conventional and commercial food products.

As used herein, “laxation effect” refers to fecal urgency, loose stools, diarrhea and associated gastrointestinal intolerance such as gas, cramping and bloating.

As used herein, “laxation threshold” means the published or experimentally determined level of consumption of a food ingredient that may cause “Taxation effect”, and is expressed in units of grams of the food ingredient consumed per day

As used herein, “prebiotic” means a substance that is a nondigestible food ingredient that beneficially affects the host by selectively stimulating the growth and/or activity of one or a limited number of bacteria in the colon, and thus improves host health.

As used herein, “probiotic” means a substance containing beneficial microorganisms or bacterial flora that is normally present in the digestive tract. A probiotic food product is a food that either typically contains or has had microorganisms beneficial to the digestive tract added. A probiotic food has also been referred to as a nutraceutical, functional food or FoSHU (“Food for Specified Health Use”). An example of the use of a probiotic food is the consumption of live bacterial cultures in yogurt to enhance the intestinal flora and so aid digestion. A probiotic food can also comprise one that contains beneficial bacteria that are introduced into the body to re-florinate the digestive tract or prevent the multiplying of pathogenic bacteria, a technique known as competitive exclusion, or competitive inhibition

As used herein, “standardized serving” means a product-appropriate serving size, by weight or by volume, as specified by law or regulation, or by industry practice. For example, U.S. Federal regulation 21 CFR 101.12 provides reference amounts customarily consumed per eating occasion for various foods, including frozen desserts. For ice cream, ice milk, frozen yogurt, and sherbet, the standardized serving can be a volume of ½ cup (118.4 ml).

Component limits and ranges given herein in percentages are by weight unless indicated otherwise.

The present invention relates to a low-digestible sweetener system that can be used in foods such as frozen desserts, confections, nutritional bars, and baked goods, and beverages, to replace sweetener systems that are high in digestible carbohydrates and are responsible for high blood glucose responses in such foods and beverages. The invention also relates to such foods comprising the low-digestible sweetener system. Substitution of sweetener systems that are high in digestible carbohydrates with low-digestible sweetener systems can provide food products that have significantly lower levels of digestible carbohydrates. For example, the low-digestible sweetener system typically will contribute about 15 grams and less, typically 12 grams and less, and more typically 8 grams and less, of digestible carbohydrate to a standardized serving of the food product, including a frozen dessert. Preferably, the sweetener system will contribute about 5 grams and less, more preferably about 3 grams and less, and most preferably about 1 to 2 grams, and less, of digestible carbohydrate to a standardized serving of the food product.

Food products made with the low-digestible sweetener system, and in particular the frozen desserts of the present invention, have organoleptic properties (such as flavor, mouthfeel, texture, and appearance) and other physical properties (such as density, freezing point, and handling properties) that are acceptable to consumers of such foods. Preferably, the organoleptic and other physical properties of the foods and frozen desserts made with the low-digestible sweetener system of the invention simulate those of food products prepared with sweetener systems containing a major amount of high-glycemic digestible carbohydrate sweeteners such as sucrose (sugar), corn syrup, high fructose corn syrup and maltose. More preferably, the organoleptic properties of food and frozen dessert products made with the low-digestible sweetener system of the present invention are not distinguishable to the typical consumer from those food products prepared with sweetener systems containing a major amount of high-glycemic digestible carbohydrate sweeteners.

An embodiment of the low-digestible sweetener system comprises an amount of at least one low molecular weight, low-digestible sweetener (hereinafter referred to as a “low-digestible sweetener”), having a molecular weight of from about 90 to about 190. Typically, the low-digestible sweetener is selected from a low molecular weight sugar alcohol, a low molecular weight saccharide, and a mixture thereof. More typically, the low-digestible sweetener system comprises a mixture of two or more low-digestible sweeteners. The low-digestible sweetener system contributes a reduced level of digestible carbohydrate to a food product, relative to high-glycemic digestible carbohydrate sweeteners.

Typical low molecular weight sugar alcohols can be selected from the group consisting of mannitol, maltitol, sorbitol, lactitol, erythritol, xylitol, isomalt, glycerin, talitol, and mixtures thereof. Typical low molecular weight saccharides can be selected from the group consisting of mannose, tagatose, fructose, arabinose, fucose, lycose, ribose, sorbose, talose, and xylose, and mixtures thereof. A preferred group of low-digestible sweeteners are those having a molecular weight of from about 90 to about 160.

One group of the low-digestible sweeteners can be characterized by having a laxation threshold less than about 150 g, and include, as examples, are mannitol, sorbitol, xylitol, hydrogenated starch hydrolysate (HSH), maltitol, lactitol, isomalt and talitol. Another group of the low-digestible sweeteners can be characterized by have a laxation threshold of about 150 g and more, and include, as examples, erythritol, glycerin, and tagatose. Erythritol, glycerin, and tagatose, and mixtures thereof, are preferred low-digestible sweeteners. This group of low-digestible sweeteners is believed to have better tolerance in the gastrointestinal system. Tagatose is a preferred sweetener. The D-tagatose form is the preferred tagatose.

Combinations of low-digestible sweeteners in a low-digestible sweetener system can be advantageously used to provide appropriate sweetening of the food or frozen dessert product. Two-way blends include: tagatose and erythritol; tagatose and fructose; tagatose and isomalt; tagatose and maltitol; tagatose and sorbitol; tagatose and glycerin; tagatose and xylitol; tagatose and lactitol; tagatose and mannitol; erythritol and fructose; erythritol and glycerin; erythritol and xylitol; erythritol and isomalt; erythritol and maltitol; and erythritol and sorbitol. Three-way blends include: erythritol, glycerin and fructose; tagatose, erythritol and fructose; erythritol, glycerin and isomalt; tagatose, erythritol and glycerin. Suitable additional three-way, four-way, five-way blends and more can also be prepared.

The low-digestible sweetener system can typically contain from about 10% to about 99%, more typically from about 40% to about 80%, by weight of the low-digestible sweetener. The low-digestible sweeteners can provide an amount of sweetness that, for an equal weight of sweetener material, is generally lower than sucrose. For example, erythritol and sorbitol, compared to sucrose, have a relative sweetness of 60-70%; mannitol is 50%; maltitol is 90%; and glycerin is 55-70%. Xylitol has a relative sweetness of 100%, while fructose is sweeter than sucrose, having a relative sweetness of 117%. Combinations of the low-digestible sweeteners can provide mixtures having a relative sweetness typically less than sucrose (sugar), and which can have a distinctive sweet taste.

The sweetener system can optionally comprise a non-nutritive sweetener to augment the sweetening power of the low-digestible sweetener. Typical non-nutritive sweeteners can be selected from the group consisting of aspartame, acesulfame salts, saccharins, cyclamates, sucralose, alitame, neotame, acesulfame-K, stevia, steviosides, glycyrrhizin, Lo Han Guo, neohesperidin dihydrochalcone, monatin, monellin, thaumatin and brazzein and mixtures thereof. The non-nutritive sweeteners can be used in combinations of two-, three-, four-, and five-way blends, or more, of individual materials, at different levels to provide sweetening power and synergistic flavor and sweetening effects with the low-digestible sweeteners. As used herein, a “non-nutritive” sweetener is one which does not provide significant caloric content in typical usage amounts, i.e., less than about 1 calorie per standardized food serving. The level of usage of non-nutritive sweeteners can typically range from about 0.05% to about 1.0%, more typically from about 0.1% to about 0.5%, by weight of the sweetener system. In the final product, the level of non-nutritive sweetener can typically range from about 0.002% to about 0.1%, more typically from about 0.010% to about 0.05%, by weight of the food product.

Preferred two-way blends include aspartame/acesulfame-K, sodium saccharin/sodium cyclamate and sucralose/acesulfame-K. Preferred three-way blends include aspartame/acesulfame-K/sodium saccharin, aspartame/acesulfame-K/sucralose, aspartame/acesulfame-K/sodium cyclamate, aspartame/sodium saccharin/sucralose, sucralose/sodium saccharin/sodium cyclamate and acesulfame-K/sodium cyclamate/sucralose. Preferred four-way blends include aspartame/acesulfame-K/sodium saccharin/sodium cyclamate, acesulfame-K/sodium saccharin/sodium cyclamate/sucralose, aspartame/acesulfame-K/sodium cyclamate/sucralose and aspartame/acesulfame-K/sodium saccharin/sucralose. Preferred five-way blends include aspartame/acesulfame-K/sodium saccharin/sodium cyclamate/sucralose.

One of ordinary skill in this art will readily appreciate that non-nutritive sweeteners can be combined in various ratios to form a non-nutritive sweetener blend suitable for use in the present invention. Precise ratios of non-nutritive sweeteners depend on the combination of sweeteners used in a given blend and the desired overall sweetness for a given application. Appropriate ratios can be readily determined by one of ordinary skill in this art.

One of ordinary skill in this art will also readily appreciate that the amount of the blend of non-nutritive sweeteners in a finished food product will vary depending on a variety of factors such as the desired overall sweetness for a given application. Appropriate amounts can be readily determined by one of ordinary skill in this art.

The low-digestible sweetener system also typically comprises an amount of a fermentable fiber material. The use of the fermentable fiber material in the food or frozen dessert can mitigate a laxation effect that can be caused by ingestion of low-digestible sweeteners. The mitigation of the laxation effect is discussed herein below.

The use of the fermentable fiber material in the foods products of the present invention provides a prebiotic ingredient that promotes and accelerates colonic fermentation. The acceleration of fermentation in the proximal colon increases conversion of the low-digestible sweeteners that may impart gastrointestinal intolerance, thereby improving the gastrointestinal tolerance of frozen dessert products containing the low-digestible sweeteners.

The fermentable fiber material participates in several mechanisms, related to the use of low-digestible sweeteners in frozen desserts and other food products, which provide reduced laxation effects. First, it serves as an energy source for colonic epithelial cells, minimizing cellular inflammation and helping to maintain a healthy mucosal barrier in the prevention of leaky gut syndrome. A healthy colon will be less susceptible to accumulating water from the consumption of foods that create high osmotic pressures in the colon. Second, the fermentable fiber material stimulates sodium and water absorption through Na⁺-H⁺exchange to act as an anti-diarrheal agent. Third, it promotes the growth of bacterial species that actively ferment the low molecular weight molecules of the low-digestible sweetener to produce short chain fatty acids, which are then readily absorbed, thus decreasing the osmotic load. (See Scheppach, W., Gut. 1994 Jan.; 35 (1 Suppl): S 35-38, incorporated herein by reference).

The fermentable fiber material can be selected from the group consisting of inulin; a maltodextrin resistant to human digestion; an oligofructose or fructooligosaccharide (FOS) (also referred to as a neosugar); polydextrose; a high water binding fermentable fiber; and a mixture thereof. Inulin is a fructose polymer resistant to human digestion and contains fructooligosaccharide (FOS) with a chain length that is included within oligosaccharides and polysaccharides. The chain length of choice for its use is dependent on the functional properties of the food application. Shorter chain inulin, which include oligofurctose and fructooligosaccharides (FOS), has a degree of polymerization range of 2 to about 20 fructose units with an average of 4-8 fructose units. The shorter chain inulins provide greater solubility, hygroscopicity, high sweetening potential, and greater overall fermentation than long chain inulin fractions. Long chain inulins can be polydispersed, being a mixture of short, medium and long chains, having a degree of polymerization (DP) range of 2 to 60 plus fructose units and an average of 9-12 fructose units. These poydispersed inulins have multifunctional properties, having solubility, modest hygroscopicity and offer some reducing power for browning in baked products. Still longer chain inulin products, such as those having a DP range of 5-60 plus and an average of 25 fructose units have a low degree of relative hygroscopicity as compared to shorter and polydispersed inulin, and may be used in low water food systems, such as chocolate and chocolate coatings where attraction of water is not desired. A typical resistant maltodextrin includes Fibersol-2™. A typical polydextrose is Litess® I, II, and III. A high water binding fermentable fiber includes a hydrocolloid selected from xanthan gum, guar gum, pectin (low methoxyl), pectin (high methoxyl), alginate, carrageenan, locust bean gum, tragacanth gum, karaya gum, konjac flour mannan, glucan, and tamarind gum.

The fermentable fiber material is a non-digestible carbohydrate, and does not contribute to the glycemic load of the food product.

The amount of fermentable fiber used in the sweetening system is typically sufficient to mitigate the laxation effect that can be caused by ingestion of the amount of the low-digestible sweetener. When the fermentable fiber is incorporated with the low-digestible sweetener into a sweetener system, the sweetener system can comprise from about 1% to about 90%, more typically from about 20% to about 60%, by weight of the fermentable fiber. A typical low-digestible sweetener system contains an amount of the fermentable fiber material and of the low-digestible sweetener system sufficient to provide a food product comprising, by weight, from about 5% to about 20%, more typically from about 10% to about 15%, of the low-digestible sweetener, and from about 2% to about 10%, more typically from about 4% to about 6%, of the fermentable fiber. When the fermentable fiber is incorporated with the low-digestible sweetener into a sweetener system, the sweetener system can comprise from about 1% to about 90%, more typically from about 20% to about 60%, by weight of the fermentable fiber.

The fermentable fiber material may also provide an amount of sweetness, or sweetener power, which can supplement the sweetening power of the low-digestible sweetener system. Resistant maltodextrins and fructo-oligosaccharides can have a level of sweetener power of up to about 40% relative to sucrose.

Another embodiment of the invention relates to the use of a low-digestible sweetener system in a frozen dessert. In this embodiment, the low-digestible sweetener system can comprise a Freezing Point Depression Sweetener for providing freezing point depression for the frozen dessert. The Freezing Point Depression Sweetener (FPDS) typically comprises at least one low-digestible sweetener, defined herein above. Erythritol, glycerin, and tagatose, and mixtures thereof, are preferred FPDSs. A FPDS, or more typically a combination of the FPDS, can provide an acceptable freezing point depression of the frozen dessert composition, which provides the frozen dessert with acceptable organoleptic and physical properties.

The low-digestible ice cream product will typically have a structure at the temperature of conventional domestic freezers (about 0 to 10° F., or −18 to −12° C.) that is sufficiently pliable to permit scoop dispensing of the ice cream from its storage container. The FPDS also provides the ice cream with an appropriate structure at the draw temperature of conventional ice cream making machines that allows the use of standard processing methods during manufacture. The draw temperature is the temperature at which ice cream is discharged from a continuous freezer in the manufacturing of an ice cream product. The ice cream product at the draw temperature and conditions has a semi-frozen consistency, has a sufficiently rigid structure to incorporate the overrun, and yet has adequate flowability for packaging of ice cream product at practical packaging speeds. The low-digestible ice cream product will typically employ a draw temperature of about 19 to 20° F. (about −7° C.). If the ice cream product is drawn at a lower temperature, its structure will be more frozen and too stiff, making it difficult to obtain the desired overrun and it will not discharge from the continuous freezer to give practical manufacturing speeds.

The Freezing Point Depression Sweetener can comprise a single low-digestible sweetener or a mixture of low-digestible sweeteners that have the appropriate freezing point depression effect on the frozen dessert product, while contributing a portion of the sweetening power to the low-digestible sweetener system. Freezing point depression is a colligative property of a solution. Colligative properties of solutions depend upon molal concentration of the solute molecules or ions. Thus when developing FPDS systems, it is preferred to choose low molecular weight low-digestible sweeteners in the molecular weight range of about 90 to about 190. The FPDS typically will contribute about 15 grams and less, typically 12 grams and less, and more typically 8 grams and less, of digestible carbohydrate to a standardized serving of the frozen dessert. Preferably, the FPDS will contribute about 5 grams and less, more preferably about 3 grams and less, and most preferably about 1 to 2 grams, and less, of digestible carbohydrate to a standardized serving of the frozen dessert. The low-digestible sweetener system typically comprises about 10% to about 99% of the FPDS.

One of ordinary skill in this art will readily appreciate that the FPDS can be combined in various ratios to form a freezing point depression suitable for the particular frozen dessert of the invention. Precise ratios of FPDS depend on the combination of FPDSs used in a given product, and the desired freezing point depression required for a given frozen dessert application. Appropriate ratios can be readily determined by one of ordinary skill in this art.

One of ordinary skill in this art will also readily appreciate that the amount of the blend of FPDSs in a finished frozen dessert will vary depending on a variety of factors such as the desired overall sweetness and the desired freezing point depression required for a given frozen dessert application. Appropriate amounts can be readily determined by one of ordinary skill in this art.

In addition to choosing the combination of FPDS based on freezing point depression performance, the combination of FPDS are also chosen for their ability to minimize osmotic pressure effects that create undesirable laxation and other conditions of gastrointestinal intolerance after ingestion of the frozen dessert. The low-digestible sweeteners used as FPDS are relatively small molecules, having a MW of 90 to 190. These sweeteners, after being consumed, predominantly by-pass the small intestine and enter the colon intact, where their presence increases colonic osmotic pressure. An exception is erythritol, which is 80% absorbed in the small intestine and excreted in urine. Some saccharides such as tagatose and sugar alcohols typically are 20 percent or less absorbed in the small intestine while the remaining amount passes to the colon for fermentation. The absorption of these sugar alcohols has a minimal effect on blood glucose response that is associated with digestible carbohydrates. High colonic osmotic pressures can cause high levels of water to enter the colon, resulting in gastrointestinal intolerance that can include cramping, diarrhea, and excessive laxation. Osmotic pressure, like freezing point pressure, is a colligative property of a solution. However, the two colligative systems tend to oppose one another: as more acceptable depression of the freezing point is achieved, unacceptable gastrointestinal intolerance may be experienced.

Gastrointestinal tolerance for the low-digestible sweeteners used as FPDSs, is a function of the weight of the individual as well as the level of the FPDSs consumed. Thus, children are more sensitive to gastrointestinal intolerance than adults as they have a shorter colon and smaller colonic mass. Intolerance to the small molecular weight low-digestible sweeteners will vary based on the consumer and the type low-digestible sweeteners consumed. For example, certain sugar alcohols have a very low laxation threshold, while others have a high laxation threshold. The laxation threshold for sorbitol and mannitol are reported to be 50 g/day and 20 g/day, respectively. By comparison, erythritol has a high laxation threshold of greater than 150 g/day. These threshold values can be lowered when amounts of the sugar alcohols are taken at one time. It has been observed that children consuming 10 g of sorbitol at one time can have significant gastrointestinal intolerance. Erythritol, glycerin, and the saccharide tagatose have a high laxation threshold, and can be consumed at higher levels with acceptable gastrointestinal tolerance. Therefore, preferred mixtures of FPDSs are selected to optimize the freezing point depression of the frozen dessert while minimizing any laxation effect.

Another embodiment of the present invention uses the low-digestible sweetener system to provide a low glycemic frozen dessert product that contains a low level of digestible carbohydrate, and which delivers a reduced glycemic response when compared to a frozen dessert that is made with a sweetener system containing a major amount of high-glycemic digestible carbohydrate sweeteners. The low glycemic frozen dessert product has a composition having a suitable freezing point depression effect that allows the frozen dessert to simulate food products prepared with sweetener systems containing a major amount of high-glycemic digestible carbohydrate sweeteners, in terms of organoleptic and other physical properties. Preferably, the frozen desserts made with the low-digestible sweetener system of the present invention are indistinguishable to the typical consumer from those frozen desserts prepared with sweetener systems containing a major amount of high-glycemic digestible carbohydrate sweeteners.

By comparison, typical conventional frozen desserts employ sweeteners that are high in digestible carbohydrates. Common sweeteners used in frozen desserts include, sugar, corn syrup, high fructose corn syrup, fructose, glucose, lactose, honey, molasses, maltose, and sugar alcohols (maltitol, maltitol syrups, sorbitol, isomalt, lactitol, erythritol, and xylitol). With the exception of the sugar alcohols and fructose, commonly used frozen dessert sweeteners generally have moderate to high glycemic indexes in the range of 50 to 110. Predominately-used frozen dessert sweeteners high in digestible carbohydrates include sucrose, corn syrup and high fructose corn syrup. Molecular weights for these sweeteners range from about 180 to about 4,000 and more. Since frozen desserts are highly consumed, they represent a significant source of digestible carbohydrates in the diet.

The frozen dessert of the present invention uses the low-digestible sweetener system to provide a freezing point depression to the frozen dessert. The frozen dessert typically comprises from about 5% to about 20%, more typically from about 10% to about 15%, of the low-digestible sweetener, and from about 2% to about 10%, more typically from about 4% to about 6%, of the fermentable fiber. The frozen dessert typically contributes about 15 grams and less, more typically about 12 grams and less, and even more typically about 8 grams and less, of digestible carbohydrate per standardized serving of frozen dessert. Preferably, the low-digestible sweetener system contributes about 5 grams and less, more preferably about 3 grams and less, and most preferably about 1 to 2 grams, and less, of digestible carbohydrate to a standardized serving of the frozen dessert. The frozen dessert also displays the organoleptic properties (texture, mouthfeel, lubricity, and flavor and sweetness release) and physical properties (appearance and handling) of a conventional frozen dessert product containing a standard level of conventional digestible carbohydrates. The use of the low-digestible sweetener system of the present invention permits development of improved frozen desserts with reduced levels of digestible carbohydrates, with effective freezing point depression that provides optimum organoleptic quality and manufacturability.

Table 1 below provides a comparison of the nutrition of frozen dessert products of the present invention, against commercial frozen dessert products prepared with sweetener systems containing a major amount of high-glyccemic digestible carbohydrate.

| Product | Serving Size | Calories | Digestible CHO | Protein | Fat | Fiber |
|---|---|---|---|---|---|---|
| Commercial Frozen Desserts: | | | | | | |
| Vanilla Ice Cream | 73 g | 200 | 21.0 | 5.0 | 10 | 0 |
| Artificial Whipped Cream | 73 g | 170 | 16.0 | 0 | 12 | 0 |
| Soft Serve Vanilla | 73 g | 109 | 17.1 | 2.3 | 3.5 | 0 |
| Vanilla Milk Shake | 73 g | 73 | 16.0 | 0 | 12 | 0 |
| Frozen Shake | 73 g | 110 | 18.1 | 2.6 | 2.6 | 0 |
| Sherbet | 73 g | 101 | 23.5 | 0.8 | 0.8 | 0 |
| Fudgesicle Bar | 73 g | 85 | 17.0 | 3.0 | 1.5 | 0 |
| Low Carbohydrate Frozen Desserts: | | | | | | |
| Vanilla Ice Cream of Example 1 | 73 g | 140 | 3.0 | 3.0 | 11 | 4 |
| Soft Serve Ice Cream of Example 2 | 73 g | 110 | 3.5 | 3.6 | 7.4 | 3.5 |
| Draw Shake of Example 3 | 73 g | 65 | 3.5 | 3.6 | 2.5 | 3.3 |

The frozen dessert of the present invention also comprises an optional non-nutritive sweetener; and a fermentable fiber material, described herein above. The frozen dessert of the present invention, having a sweetening system that contains only FPDSs and the optional non-nutritive sweeteners can significantly reduce the glycemic response to the frozen dessert product.

A typical embodiment of a frozen dessert of the present invention is a low-carbohydrate ice cream product, comprising at least 10% milkfat, a low-digestible sweetener system that comprises at least one low-digestible sweetener, an optional non-nutritive sweetener, and a fermentable fiber material, as described herein above. The ice cream product can include a packaged ice cream and soft-serve ice cream.

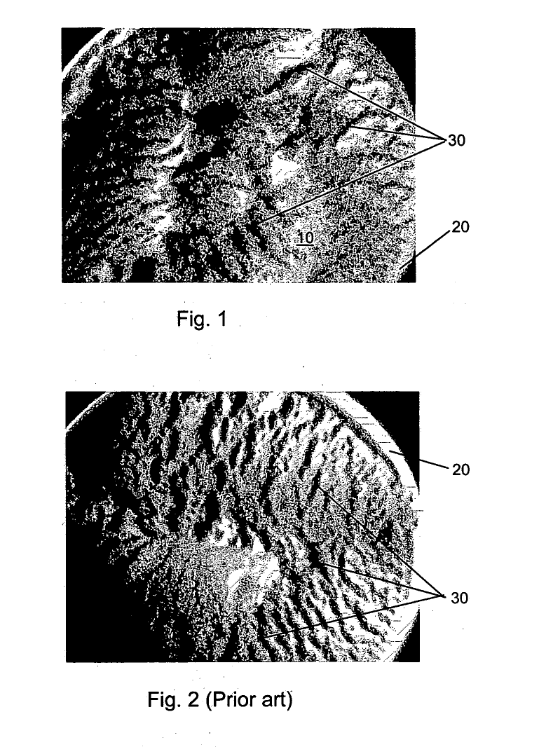

One important visual property of an ice cream product that is important to consumers is the rippling of the ice cream product when it is scooped out of a frozen container. FIG. 1 shows an ice cream product 10 of the present invention in its container 20 immediately after a scoop of the ice cream is taken. As can be seen, the exposed surface of the ice cream product in the container displays a rippling pattern 30 of small ridges and valleys that simulate similar rippling patterns when scooping a typical high-glycemic ice cream shown in FIG. 2.

Another embodiment of the ice cream product of the present invention can comprise at least 10% milkfat, a freezing point depression system comprising, and typically consisting essentially of, at least one FPDS, at least one non-nutritive sweetener, and a fermentable fiber material.

The low-digestible ice cream product will typically have a structure at the temperature of conventional domestic freezers (about 0 to 10° F., or −18 to −12° C.) that is sufficiently pliable to permit scoop dispensing of the ice cream from its storage container. The FPDS also provides the ice cream with an appropriate structure at the draw temperature of conventional ice cream making machines that allows the use of standard processing methods during manufacture. The draw temperature is the temperature at which ice cream is discharged from a continuous freezer in the manufacturing of an ice cream product. The ice cream product at the draw temperature and conditions has a semi-frozen consistency, has a sufficiently rigid structure to incorporate the overrun, and yet has adequate flowability for packaging of ice cream product at practical packaging speeds. The low-digestible ice cream product will typically employ a draw temperature of about 19 to 20° F. (about −7° C.).

Consequently, the present invention provides for the use of a low-digestible sweetener system in a frozen dessert, and in particular in an ice cream, to provide the frozen dessert with a draw temperature of from about 19 to 20° F. (about −7° C.). Preferably, the use of the low-digestible sweetener system provides the frozen dessert with a scoopable structure in a temperature range from about 0° F. (−18° C.) to about 10° F. (−12° C.). As with conventional ice cream products, it is within the skill of those familiar with ice cream formulation to select the type of levels of one or a combination of low molecular weight sugar alcohols and saccharides to provide the appropriate freezing point depression for the ice cream product, including the appropriate draw temperature characteristics and structure for appropriate manufacturing of the frozen dessert, and for the appropriate storage structure for acceptable dispensing of the packaged frozen dessert.

The ice cream of the present invention can optionally contain other dairy ingredients, caseinates, and hydrolyzed milk proteins, in accordance with applicable regulations, such as US Federal regulation 21CFR 135.110, incorporated herein by reference.

Other frozen dessert products of the present invention can include, but are not limited to, milk shakes and draw shakes. Advantageously, the frozen desserts of the present invention can be produced using standard frozen dessert processing equipment and processing methods. Standards for frozen desserts are published in the United States by states and the United States Federal Government. Federal regulations for frozen desserts are published in Title 21 CFR (Code of Federal Regulations), Part 135. These regulations provide definitions and requirements for specific standardized frozen desserts. Title 7 of the Pennsylvania Code, Chapter 39 (No. 262 Sep. 96) also provides detailed standards for frozen desserts.

Optional Nutritional Fortification:

Frozen desserts are not typically considered to be nutritious or highly nutritious. Although some frozen desserts can be a good source of protein, they are generally high in digestible carbohydrates and lack healthy sources of fats, fiber and micronutrients. Since deleterious levels of digestible carbohydrates can be excluded by the invention, the low glycemic frozen dessert of the present invention can be a good delivery system for nutritional fortification. A frozen dessert further comprises at least one supplemental nutrient, in an amount sufficient to achieve fortification, or in amounts and types of supplementation that provide meal replacement levels that achieve one-third to one-half of the Recommended Daily Intake (RDI) of such nutrient. The supplemental nutrients can include protein, fiber vitamin A, vitamin C, calcium, iron, vitamin D, vitamin E, thiamine, riboflavin, niacin, vitamin B6, folate, vitamin B12, biotin, pantothenic acid, phosphorus, magnesium, zinc, iodine, copper, and potassium, in total or in part, by a serving of the frozen dessert. Other supplemental nutrients can include other macronutrients, other micronutrients, other trace elements, phytonutrients and nutraceuticals, and combinations thereof.

In addition, the food products and frozen desserts of the present invention can comprise additional probiotic materials to augment the beneficial fermentation in the proximal colon. Such probiotic materials can include, as examples, live cultures of bifidobacterium, lactobacillus acidophilus and lactobacillus bulgaricus, and other species of lactobacilli.

Other Optional Ingredients

The low-digestible sweetener system of the present invention, and the low-digestible foods and frozen desserts made therefrom, can optionally comprise low levels of a conventional digestible sweetener, such as sugar or sucrose, for its sweetness or flavor release properties. Typically, since the conventional digestible sweetener provides digestible carbohydrates and a glycemic response, such that low levels are typically used when designing a food product that provides a low level of digestible carbohydrate.

The low-digestible foods and frozen desserts can also optionally contain other components with fiber properties, including a non-fermentable or a partially-fermentable fiber such as lignin, cellulosic material, chitin, and chitosan.

Another embodiment of the present invention comprises a frozen dessert product comprising a fermentable fiber material. The fermentable fiber material is described herein above. These materials, and in particular dietary fibers, are not usual nutritional elements of a conventional frozen dessert. It has been discovered that the use of the fermentable fiber materials provide unique health benefits in the present low-digestible frozen desserts, as well as in conventional frozen dessert products prepared with sweetener systems containing a major amount of high-glycemic digestible carbohydrate.

Consequently, the present embodiment provides a nutritionally enhanced frozen dessert that provides the above-identified health benefits associated with fermentable fibers, when used in either a low-digestible frozen dessert or in a conventional frozen dessert. It has also been observed that certain fermentable fiber materials, such as dietary fiber, and in particular inulin, provide prebiotic benefits that enhance colonic fermentation. It has also been observed that certain fermentable fiber materials, such as dietary fiber, and in particular inulin, can provide an improved organoleptic property, such good mouthfeel, due to their fat-mimicking properties. Fiber levels can be added that can contribute to meeting the daily fiber requirements.

Blends of Low-Digestibel Sweeteners in Various Foods:

The present invention can comprise a low-digestible sweetener system that typically comprises a blend or mixture of low-digestible sweeteners, and a fermentable fiber, and optionally a non-nutritive sweetener. The typical blends can include 2, 3 4 or more low-digestible sweeteners, depending upon the functional and physiological properties desired for the particular food in which the low-digestible sweetener system is used.

The invention typically comprises a low-digestible sweetener system comprising a mixture of a plurality of low-digestible sweeteners. These functional sweetener blends are typically formulated to satisfy the functional and physiological properties for sugar replacement in food, to perform effectively in such foods that are marketed as acceptable to consumers. The key technological properties of each food application are taken into account in formulating the low-digestible sweetener mixture or blend, in addition to balancing the digestive tolerance of the low-digestible sweeteners blend. The objective is to make a low-digestible food that has similar or better eating quality as the full-sugar food counterpart, without any untoward digestive issues.

Each food application has specific functional and nutritional requirements that require specific consideration to be given for the physico-chemical properties of the sugars that a system of ingredients, like oligosaccharides, polyols and inulin, would replace. These physico-chemical properties include, but are not limited to: colligative properties, including freezing point depression, boiling point rise, osmolality (osmotic pressure), vapor pressure and A_{w} effects; solubility; viscosity (solution); bulk density; dielectric constant (microwave heating); purity; sensory properties; color; antioxidant properties; and sweetness.

Each ingredient has specific values for each property and has certain synergies with other(s) of the ingredients, such as sweetness, viscosity, taste influences, browning effects, and various fermentation patterns, that when exploited offer enhanced, sugar replaced, healthier foods having excellent eating quality and health-promoting fiber content, without untoward digestive issues as are common with simple sugar alcohol systems.

When selecting specific ingredients to replace sugar for a specific food application, the following non-limiting examples of variables are important to the final food product: browning of the food, as in baking applications (i.e. cookies, cakes, and muffins); the degree of hygroscopicity (attaction of water) for chocolate and confection applications; and the laxation threshold. Ingredients used in the invention have different levels of browning based on the reducing power of each sugar ingredient used in the formulation. By example, tagatose is a reducing sugar, like glucose, and inulin, while not being a strong reducing sugar, has naturally-occurring glucose that does create some level of reduction or browning in baked products.

For example in baked products, it can be desireable to minimize browning effects by choosing carbohydrate entities that offer some of the other properties, such as higher Taxation thresholds, low level hygroscopicity, and low levels of reducing sugars. Examples of carbohydrates having low hygroscopicity, higher laxation thresholds and low browning effects are erythritol and polydextrose. However, some sugar alcohols, xylitol and erythritol have a negative heat of solution creating cooling effects in foods when used above about 15%. This can create the need to mask the cooling effects of these sugar alcohols, while balancing the browning effects of other non-digestible carbohydrates, like inulin and tagatose that are used in the formulation. An aspect of the invention is to achieve the primary functional properties of the food, while giving consideration to the functional and physiological laxation threshold of the sugar replacement system.

Chocolate is a fat system, rather than a water system, so selection of sugar replacement ingredients requires selecting ingredients that have very low hygroscopicity, such as erythritol, isomalt, lactitol, long chain inulin that do not attract water, that would create significant processing problems.

Hard confections require significant solubility considerations, thus necessitating the used of highly soluble non-digestible carbohydrates such as short chain inulin or fructooligosaccharides/oligofructose, and isomalt, while the composition must not be overly hygroscopic so as to minimize surface stickiness. Soft confections require systems that add softness (greater hygroscopicity and solubility) such as shorter chain inulin, maltitol or HSH-syrups along with some less hygroscopicity components to balance the level of hygroscopicity and solubility. In some systems, the sweetness balance can be managed by incorporating a non-nutritive sweetener, like aspartame or sucralose or a blend of aspartame and acesulfame potatssium. Glycerin, being highly hygroscopic is typically used as a softening agent and moisture enhancing agent, when used by itself or with other like components, such as sorbitol.

In a typical embodiment, the low-digestible sweetener system is intended to be used as a replacement for sugar in a food formulation on a weight-to-weight basis.

Method:

A. Digestible Carbohydrate in a Food Serving

One method for determining the amount of digestible carbohydrate in a serving of food involves feeding about a 30 g food sample to a human subject, followed by quantifying the sample's blood glucose response. The blood glucose response is used to extrapolate the level of digestible carbohydrate (expressed as grams of glucose) from a standard blood glucose response curve for glucose.

The standard blood glucose response curve for glucose is based on the results of 9 human subjects. Each subject should be healthy, between the ages of 20 to 35 (the younger age range is sought in order to reduce metabolic variability that is associated with aging, possess ideal weight for their height (normalized weight is sought in order to standardize the lag time between increases in blood glucose and subcutaneous interstitial glucose at the point of sampling and to reduce metabolic variability), and not have a known metabolic disorder. Triplicate assay results are determined for each level of glucose used to establish the standard curve. The blood glucose response to a glucose standard or product sample is determined after a 12-hour overnight fasting period.

A baseline response curve is prepared by consuming 50 ml of a standard level of an aqueous glucose solution followed by measuring the subject's blood glucose response each 15 minutes during the following two-hour period. The blood glucose response is similarly measured after consumption of the food sample and the ingestion of 50 ml of water.

The blood glucose response levels are based on measurement of capillary whole blood. Blood glucose concentration is determined using YSI 2300 STAT Plus Glucose and Lactate Analyzer. The YSI analyzer provides high precision (±2% of reading at 2.5 mg/dL) and accurate results for whole-blood glucose and lactate. See www.ysi.com/. The incremental area under the curve (IAUC) is calculated as the area of the response above the baseline.

A blood glucose response standard curve is obtained by plotting the IAUC versus grams of glucose for the consumption of 1 gram, 3 grams, 7 grams and 15 grams of glucose. The regressed results for all subjects used in the preparation of the standard curve should fall within a 90% confidence limit. Outlying subjects are eliminated. Outlier data should be treated by normally accepted statistical practices. Standard curves should be validated periodically.

Food samples are tested using about 30 g samples. Samples are ingested by one or more of the human subjects that have participated in the preparation of the standard blood glucose response curve for glucose. Duplicate test results are obtained. When questionable results are experienced, duplicate samples should be performed on three participating subjects.

The equivalent amount of glucose for a specific weight of food that is other than the weight of the test sample (i.e. a serving size) is the grams of digestible carbohydrate determined for the test sample multiplied times the normalized weight of food (i.e. a serving size) divided by the weight of the test sample.

### EXAMPLES

The examples herein presented are to provide further illustration of the inventions and should in no way be interpreted as being further limiting. In the following examples, the Erythritol is Eridex®, available from Cerestar (Hammond, Ind.). The inulin is Frutafit® HD, available from Sensus America. The stabilizer is MSI 9200®, available from Main Street Ingredients. All percentages are by weight percent, unless otherwise indicated.

The frozen dessert products were produced using conventional processing equipment and procedures.

### Example 1

Digestible Carbohydrate Ice Cream —3 Grams of Digestible Carbohydrate per 73.00 Gram Serving

Formula:

Cream (40% fat)—about 33% (to balance to 100%)

Whole Milk (3.25% fat)—48.17%

Whey Protein Concentrate—2.00%

Erythritol—5.25%

Isomalt—4.25%

Inulin—5.50%

Glycerin—1.65%

Vanilla Flavor—0.5%

Stabilizer—0.16%

Sucralose—0.016%

Procedure: One-half of the milk, whey protein concentrate, erythritol, Isomalt, inulin, stabilizer and sucralose, are pre-mixed and liquefied to a slurry, which is pumped to batch tank. The other half of milk is added and mixed. The cream and glycerin are then added into batch tank and mixed. The mixture is then HTST (high temperature, short time) pasteurized at 180° F. (82° C.) for 30 seconds, and homogenized at 1500/500 psi after regeneration in a pasteurizing heat exchanger to 140° F. (60° C.). The pasteurized product is cooled to 40° F. (4° C.) or less, complying with applicable health regulation and placed in a storage tank. The products is pumped to a flavor tank where vanilla flavor and a probiotic are added with mixing, resulting in the final composition. The final composition is frozen to 19-20° F. (−7° C.), then hardened to 0° F. to −10° F. (−18° C. to −23° C.), resulting in an overrun of 80%. The hardened product is then final packaged and stored at −10° F. (−23° C.).

### Example 2

Low Digestible Carbohydrate Soft Serve Ice Cream—3.5 Grams of Digestible Carbohydrate per 73.00 Gram Serving

Formula:

Cream (40% fat)—6.45%

Whole Milk (3.25% fat)—70.5% (to balance to 100%)

Whey Protein Concentrate—2.60%

Erythritol—5.50%

Isomalt—6.00%

Inulin—6.50%

Glycerin—0.50%

Vanilla Flavor—0.5%

Stabilizer—0.35%

Sucralose—0.015%

Non Fat Dry Milk—1.08%

Procedure: The procedure for preparing the Soft Serve Ice Cream is similar to the procedure in Example 1 for preparing the ice cream, except that the flavor is mixed into the pasteurized product. The material is then packaged and maintained at 40° F. (4° C.), until added into a Soft Serve machine, where it is frozen, typically at 20° F. (−7° C.) for dispensing.

### Example 3

Low Digestible Carbohydrate Direct Draw Shake—3.5 Grams Of Digestible Carbohydrate per 73.00 Gram Serving

Formula:

Cream (40% fat)—2.75%

Whole Milk (3.25% fat)—about 70% (balance to 100%)

Whey Protein Concentrate—2.60%

Erythritol—4.00%

Isomalt—4.00%

Inulin—4.75%

Glycerin—1.20%

Vanilla Flavor—0.5%

Stabilizer—0.18%

Sucralose—0.015%

Procedure: The procedure for preparing the Draw Shake is similar to the procedure in Example 2 for preparing the Soft Serve ice cream, except that the material is added to and frozen in a Draw Shake machine for dispensing.

### Example 4

A blend of low-digestible sweetener, fermentable fiber, and optional non-nutritive sweetener are prepared, and are formulated into a variety of food products, including ice cream, cookies, confections and coatings, cake, chewing gum, icings, candies and ready-to-eat cereals. Table 2 shows the specific formulas used and the food form in which it is used. The level of these low-digestible sweetener systems in the particular low-digestible food product is approximately the same by weight as the level of sugar in conventional food products.

TABLE 2

| | | sugar | | sugarless | | sugar | sugar | | sugar | |
|---|---|---|---|---|---|---|---|---|---|---|
| | sugar | free | sugar | chocolate | sugar | free | free | sugar | free | sugar |
| | free | ice | free | & | free | chocolate | chocolate | free | angel | free |
| | ice | cream | cookie | coatings | gummy | dark | coating | cookie | food | breath |
| | cream | II | I | I | confection | chocolate II | III | II | cake | mint |
| | Sweetener blend formula no. | | | | | | | | | |
| | I | II | III | IV | V | VI | VII | VIII | IX | X |
| | PARTS | | | | | | | | | |
| sugar alcohol and low | | | | | | | | | | |
| molecular weight saccharides | | | | | | | | | | |
| crystalline maltitol | | | 60.0 | 45.0 | | 45.2 | | 64.9 | | |
| HSH-maltitol | | | | | 77.8 | | | | | |
| xylitol | | | | | | | | | | |
| erythritol | 31.5 | 30.1 | | 15.0 | 4.1 | 16.5 | | | | 36.7 |
| sorbitol | | | | | | | | | | |
| isomalt | 25.5 | | | | | | 70.0 | | | |
| glycerin | 9.9 | 9.9 | | | 1.5 | | | | | |
| lactitol | | | | | | | | | | |
| fructose | | | | | | | | | | |
| tagatose | | 24.6 | | | | 6.0 | | 4.8 | | |
| Non-digestible carbohydrate/ | | | | | | | | | | |
| fermentable fiber | | | | | | | | | | |
| inulin | 33.0 | 35.3 | 40.0 | 40.0 | 6.1 | 32.3 | 30.0 | 30.4 | 40.2 | 63.3 |
| resistant maltodextrin | | | | | 4.8 | | | | 59.8 | |
| fructooligosaccharide/ | | | | | | | | | | |
| oligofructose (FOS) | | | | | | | | | | |
| arabinogalactan | | | | | 5.7 | | | | | |
| Non-nutritive sweetener | | | | | | | | | | |
| aspartame | | | | | | 0.001 | | | | |
| acesulfame potassium | | | | | | | | 0.002 | 0.001 | |
| sucralose | 0.096 | 0.085 | 0.002 | | | | 0.001 | | | |
| stevia | | | | | | | | | | 0.001 |
| TOTAL PARTS | 100.0 | 100.0 | 100.0 | 100.0 | 100.0 | 100.0 | 100.0 | 100.0 | 100.0 | 100.0 |

| | | | | | | | | sugar | sugar | |
|---|---|---|---|---|---|---|---|---|---|---|
| | sugar | sugar | sugar | | sugar | sugar | | free | free | |
| | free | fee | free | sugar | free | free | | icings | icing | |
| | chewing | hard | hard | free | chewing | peppermint | sugar | and | and | ready- |
| | gum | confections | confections | soft | gum | patty | free | glaze | glaze | to-eat |
| | I | I | II | confections | II | center | caramel | I | II | cereals |
| | Sweetener blend formula no. | | | | | | | | | |
| | XI | XII | XIII | XIV | XV | XVII | XVIII | XIV | XV | XVI |
| | PARTS | | | | | | | | | |
| sugar alcohol and low | | | | | | | | | | |
| molecular weight saccharides | | | | | | | | | | |
| crystalline maltitol | | | | 29.8 | | | 22.9 | 60.0 | 35.2 | |
| HSH-maltitol | 30.7 | | | | 27.6 | | | | | |
| xylitol | | | | | | | | | | |
| erythritol | 32.8 | | 15.0 | 24.4 | 23.9 | | 14.9 | | | 12.1 |
| sorbitol | | | | | | 10.7 | | 0.5 | 0.5 | |
| isomalt | | 52.2 | 34.3 | | | 60.4 | | | | 29.2 |
| glycerin | 0.0 | | | | 0.0 | 15.4 | | | | |
| lactitol | | | | | | | | | | |
| fructose | | | | | | | | | | |
| tagatose | | 12.0 | 13.0 | | 33.3 | | 28.0 | | 22.2 | 35.0 |
| Non-digestible carbohydrate/ | | | | | | | | | | |
| fermentable fiber | | | | | | | | | | |
| inulin | 36.4 | 35.8 | 37.7 | 45.8 | 15.1 | 13.5 | 34.2 | 39.5 | 35.2 | 23.7 |
| resistant maltodextrin | | | | | | | | | 6.9 | |
| fructooligosaccharide/ | | | | | | | | | | |
| oligofructose (FOS) | | | | | | | | | | |
| arabinogalactan | | | | | | | | | | |
| Non-nutritive sweetener | | | | | | | | | | |
| aspartame | | | | | | | 0.001 | | | |
| acesulfame potassium | | | | | | | 0.001 | | | |
| sucralose | 0.001 | | | | | 0.001 | | 0.002 | | |
| stevia | | | | | | | | | | |
| TOTAL PARTS | 100.0 | 100.0 | 100.0 | 100.0 | 100.0 | 100.0 | 100.0 | 100.0 | 100.0 | 100.0 |

1-14. (canceled)

15. A low-digestible sweetener system for use in foods and beverages, the sweetener system comprising:
a) an amount of at least one low-digestive sweetener having a molecular weight of from about 90 to about 190, and having a laxation threshold less than about 150 g;
b) an optional non-nutritive sweetener; and
c) an amount of a fermentable fiber material, wherein the amount of fermentable fiber used is sufficient to mitigate a laxation effect that can be caused by ingestion of the amount of the low-digestive sweetener.

16. The low-digestible sweetener system according to claim 15 wherein the sweetener system comprises at least one additional low-digestible sweetener having a laxation threshold of about 150 g or more.

17. ) The low-digestible sweetener system according to claim 15 wherein the amount of low-digestive sweetener is about 10% to about 99%, and the amount of fermentable fiber material is about 1% to about 90%, by weight of the low-digestible sweetener system.

18. The low-digestible sweetener system according to claim 16 wherein the low-digestible sweetener is selected from the group consisting of mannitol, maltitol, sorbitol, lactitol, erythritol, xylitol, isomalt, glycerin, talitol, mannose, tagatose, fructose, arabinose, fucose, lycose, ribose, sorbose, talose, and xylose, and mixtures thereof.

19. The low-digestible sweetener system according to claim 15 wherein the fermentable fiber material is selected from the group consisting of inulin, a maltodextrin resistant to human digestion, an oligofructose, a fructooligosaccharide, a high water binding fermentable fiber, and a mixture thereof.

20-23. (canceled)
